(19) United States
(12) Patent Application Publication
(10) Pub. No.: US 2017/0036237 A1
(43) Pub. Date: Feb. 9, 2017

(54) Paint Roller

(71) Applicant: Lehman D. Warner, Goetzville, MI (US)

(72) Inventor: Lehman D. Warner, Goetzville, MI (US)

(21) Appl. No.: 15/206,393

(22) Filed: Jul. 11, 2016

Related U.S. Application Data
(60) Provisional application No. 62/201,333, filed on Aug. 5, 2015.

(51) Int. Cl. B05C 17/02; B25G 1/04; B25G 3/36

(52) U.S. Cl. CPC B05C 17/0227; B05C 17/0205; B25G 3/36; B25G 1/04

(57) ABSTRACT

A paint roller for painting corners and other angled surfaces. The paint roller includes a handle having a forked end from which a pair of arms extends. The pair of arms are preferably perpendicular in configuration. A roller can be positioned over each arm wherein the rollers are capable of rotating around the arms. In some embodiments, the arms are removably secured to the forked end of the handle so as to allow the user to utilize one or two paint rollers while painting. In this way, the device allows a user to paint the surfaces on opposing sides of a corner in a single stroke, allowing the user to more easily paint posts and other similar surfaces.

### CROSS REFERENCE TO RELATED APPLICATION

This application claims the benefit of U.S. Provisional Application No. 62/201,333 filed on Aug. 5, 2015. The above identified patent application is herein incorporated by reference in its entirety to provide continuity of disclosure.

### BACKGROUND OF THE INVENTION

### Field of the Invention

The present invention relates to painting tools. More specifically, the present invention provides a paint roller configured to allow a user to facilitate painting of a corner, a post, or other angled surface.

While painting, it is often necessary to paint corners and other angled surfaces. Decks and porches may have a plurality of posts or spindles that must be individually painted. In order to paint a post the user has to paint all sides of the post using a single paint roller. This can be time consuming and tedious as the person must paint each side of the post individually. Further, reaching the interior sides of the post can be particularly troublesome as the paint roller handle may get in the way.

Devices have been disclosed in the prior art that relate to painting tools. These include devices that have been patented and published in patent application publications. These devices generally relate to dual paint rollers, such as U.S. Pat. No. 8,832,897, U.S. Pat. No. 5,983,437, U.S. Pat. No. 4,335,484, U.S. Pat. No. 4,644,604, U.S. Pat. No. 5,970,568, U.S. Pat. No. 5,035,022, and U.S. Design Pat. No. D549,966.

These prior art devices have several known drawbacks. While many devices in the prior art include multiple rollers, such devices generally include the roller positioned along a single axis such that the paint roller can be used to paint a larger width on a flat surface. The devices in the prior art fail to provide a paint roller having a pair of arms fixed such that the arms are perpendicular to one another for allowing the user to more easily paint a post.

In light of the devices disclosed in the prior art, it is submitted that the present invention substantially diverges in design elements from the prior art and consequently it is clear that there is a need in the art for an improvement to existing paint roller devices. In this regard the instant invention substantially fulfills these needs.

### SUMMARY OF THE INVENTION

In view of the foregoing disadvantages inherent in the known types of paint rollers now present in the prior art, the present invention provides a new paint roller wherein the same can be utilized for providing convenience for the user when painting around corners or painted angled surfaces.

The present invention provides a paint roller having a handle with a forked end from which a pair of arms extends. The pair of arms are oriented such that they are perpendicular to one another. The arms each removably receive a cylindrical roller thereon, wherein the roller can rotate about the arm. In some embodiments, the arms are removably securable to the forked end of the handle so as to allow the user to utilize one or both arms depending on the surface desired to be painted. In some embodiments, an extension handle is further provided, wherein the extension handle is securable to the first end of the handle so as to elongate the handle to provide the user with a greater reach.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of the paint roller.

FIG. 2 shows a front perspective view of the paint roller with a roller removed.

FIG. 3 shows a front perspective view of an alternate embodiment of the paint roller.

FIG. 4 shows a top-down cross sectional view of the paint roller as used to paint a post.

FIG. 5 shows a perspective view of the paint roller as used to paint a post.

### DETAILED DESCRIPTION OF THE INVENTION

Reference is made herein to the attached drawings. Like reference numerals are used throughout the drawings to depict like or similar elements of the paint roller. For the purposes of presenting a brief and clear description of the present invention, the preferred embodiment will be discussed as used for painting a post, spindle, column, a corner, or any other angled surface. The figures are intended for representative purposes only and should not be considered to be limiting in any respect.

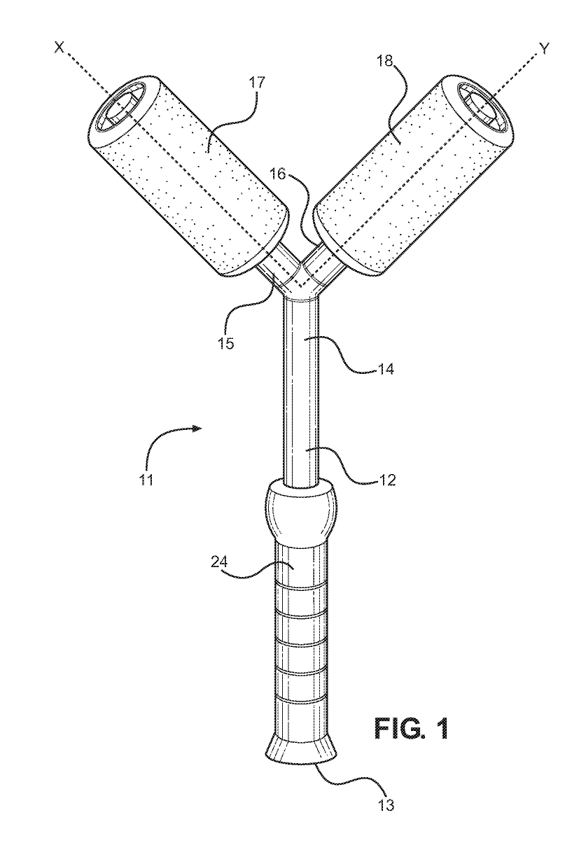

Referring now to FIG. 1, there is shown a front perspective view of the paint roller. The paint roller 11 comprises a handle 12 having a first end 13 and a second end 14. The handle 12 is preferably substantially linear in configuration. In the illustrated embodiment, the handle 12 has a cylindrical configuration. However, in alternate embodiments, the handle 12 may have other configurations, such as a square cross sectional area. The first end 13 of the handle 12 includes a grip thereon to allow the user to more easily grasp the handle 12. The grip may include rubber or a padded material to provide comfort to the user and to reduce the risk of the handle slipping in the user's hand.

The second end 14 of the handle 12 is forked so as to form a Y-shaped configuration. A pair of arms 15, 16 extend from the second end 14 of the handle 12. The arms 15, 16 are substantially perpendicular to one another. The arms 15, 16 are disposed in the same plane as the handle 12. Each arm 15, 16 is linear and preferably includes a cylindrical configuration. Further, each arm 15, 16 is configured to slideably receive a tubular roller 17, 18 thereon.

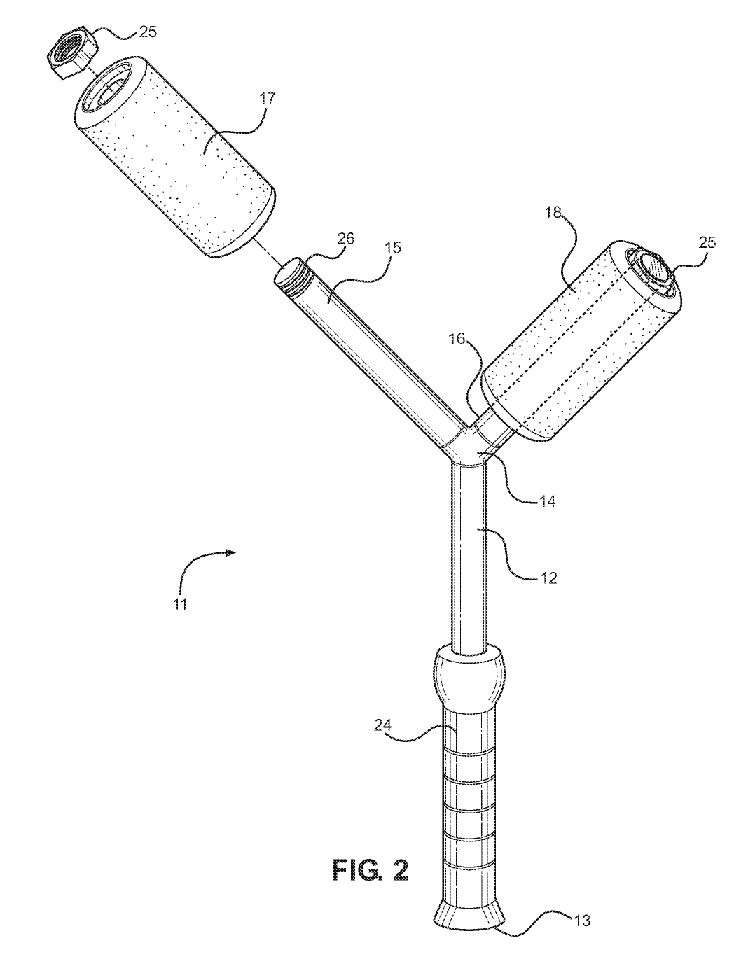

Referring now to FIG. 2, there is shown a front perspective view of the paint roller with a roller removed. The tubular roller 17, 18 is removably positionable over each arm 15, 16 such that the tubular rollers 17, 18 are able to rotate around the arms 15, 16. The rollers 17, 18 include a hollow bore therethrough, wherein the bore is adapted to be positioned over an arm 15, 16. The rollers 17, 18 then rotate about the arms 15, 16 as the user is painting.

In one embodiment, the rollers 17, 18 are prevented from accidentally sliding off the arms 15, 16 by a fastener 25, such as a nut, clip, and the like, configured to removably attach to each arm 15, 16. In the shown embodiment, the fastener 25 is a nut adapted to threadably secure to the distal end 26 of each arm 15, 16. In addition, the second end 14 of the handle 12 is integral to the pair of arms 15, 16. However, in alternative embodiments, the pair of arms 15, 16 may be removable.

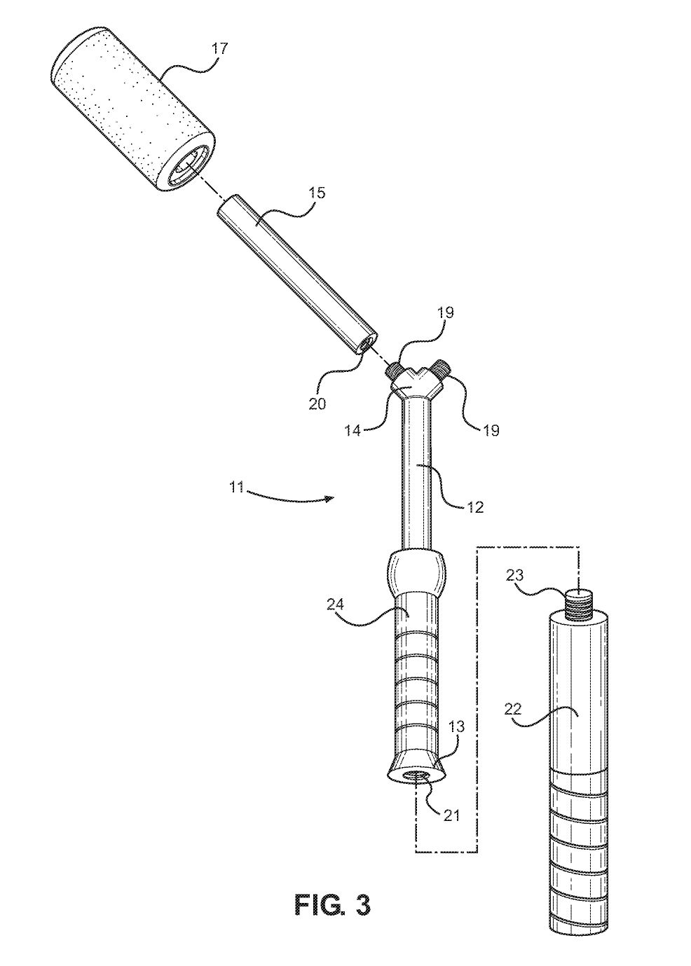

Referring now to FIG. 3, there is shown a front perspective view of an alternate embodiment of the paint roller. In some embodiments, the arms 15 are removably securable to the second end 14 of the handle 12. The second end 14 of the handle 12 includes a pair of threaded members 19, wherein one arm 15 can be secured to each threaded member 19. The arms 15 include a hollow opening at the end thereof with internal threading 20 that engages the threaded member 19 on the handle 12. In this way, the user can selectively utilize one arm alone for painting a flat surface in the conventional manner, or the user can secure both arms for more easily painting a corner or a post.

Further, an extension handle 22 is provided, wherein the extension handle 22 is securable to the first end 13 of the handle 12. The extension handle 22 is preferably linear in configuration and comprises the same cross sectional area as the handle 12. A first end of the extension handle includes threading 23 thereon adapted to engage with a threaded opening 21 on the first end 13 of the handle 12. In this way, the user can secure the extension handle 22 to the handle 12 in order to extend the length of the handle 12, providing the user with a greater reach.

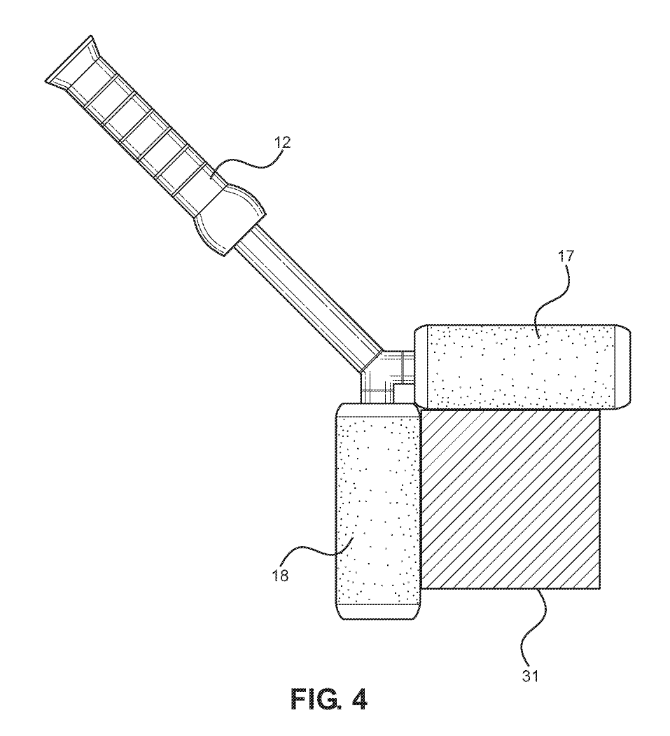

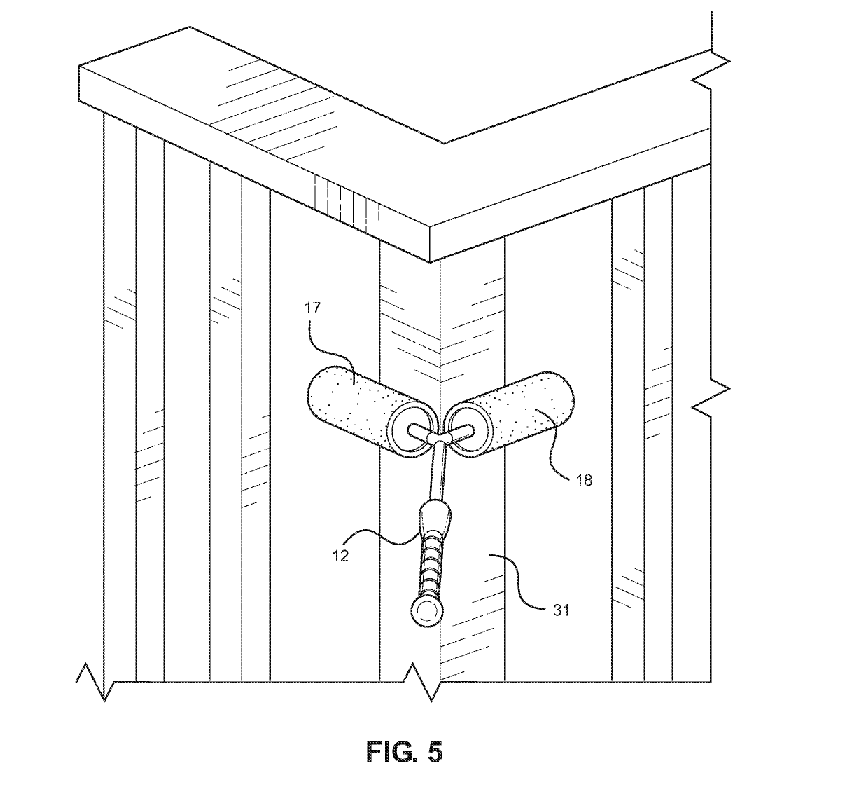

Referring now to FIGS. 4 and 5, there are shown views of the paint roller in use for painting a post. In operation, the user can utilize the paint roller 11 so as to paint two surfaces of a post 31 or corner at the same time. This minimizes the amount of time needed to paint a post 31 by eliminating the need for the user to individually paint each side of the post 31. The user can position a tubular roller 17, 18 over each arm of the paint roller 11 and can dip the tubular rollers 17, 18 in paint. The user can then position the rollers 17, 18 against two sides of a post 31 at a corner thereof. The handle 12 of the paint roller 11 extends away from the post 31 so that the handle 12 does not contact an adjacent post 31 or other surface. The user can then maneuver the paint roller 11 up and down the length of the post 31 to simultaneously paint two sides of the post 31.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A paint roller, comprising:
a handle having a first end and a second end, wherein the second end comprises a pair of arms affixed thereto, the pair of arms extending in the same plane as the handle;
wherein the pair of arms are substantially perpendicular to one another;
a tubular roller rotatably positioned over each of the pair of arms.

2) The paint roller of claim 1, wherein each of the pair of arms is substantially linear in configuration.

3) The paint roller of claim 1, wherein each of the pair of arms is removably securable to the second end of the handle.

4) The paint roller of claim 3, wherein each of the pair of arms comprises a threaded opening thereon that removably engages with a threaded protrusion disposed on the second end of the handle.

5) The paint roller of claim 1, further comprising an extension handle removably securable to the first end of the handle.

6) The paint roller of claim 1, wherein the handle comprises a cylindrical configuration.

7) The paint roller of claim 1, wherein the pair of arms is positioned in the same plane as the handle.

8) The paint roller of claim 1, wherein the tubular roller is removably securable to each of the pair of arms via a fastener.
